(19) United States
(12) Patent Application Publication
(10) Pub. No.: US 2011/0257064 A1
(43) Pub. Date: Oct. 20, 2011

(54) Solid Laundry Detergent Composition Having a Dynamic In-Wash PH Profile

(76) Inventors: Alan Thomas Brooker, Newcastle upon Tyne (GB); Neil Joseph Lant, Newcastle upon Tyne (GB); Nigel Patrick Somerville Roberts, Newcastle upon Tyne (GB); Colin Ure, Tyne and Wear (GB); Carly Pickering, Tyne and Wear (GB)

(21) Appl. No.: 13/085,771

(22) Filed: Apr. 13, 2011

(30) Foreign Application Priority Data
Apr. 19, 2010 (EP) 10 160 338.9

(51) Int. Cl. C11D 3/60; C11D 3/08; C11D 17/06; C11D 1/65; C11D 3/386; C11D 17/00

(52) U.S. Cl. 510/309; 510/302; 510/320; 510/337; 510/349; 510/357

(57) ABSTRACT

A free-flowing solid laundry detergent composition including: (a) detersive surfactant; (b) essentially free from zeolite builder; (c) essentially free from phosphate builder; and (d) optionally, essentially free from silicate salt; wherein the composition has a reserve alkalinity to pH 7.5 of less than 15, and wherein upon dilution in de-ionised water to form a wash liquor at 10° C. temperature and at 1 g/L concentration has a pH profile such that: (i) 3 minutes after contact with water, the pH of the wash liquor is greater than 10; (ii) 10 mins after contact with water, the pH of the wash liquor is less than 9.5; (iii) 20 mins after contact with water, the pH of the wash liquor is less than 9.0; and (iv) optionally, wherein, the equilibrium pH of the wash liquor is in the range of from above 7.0 to 8.5.

### FIELD OF THE INVENTION

The present invention relates to a solid laundry detergent composition having a dynamic in-wash pH profile. More specifically, upon contact with water, the laundry detergent compositions of the present invention provide a wash liquor having an initial highly alkaline pH, followed by a subsequent reduction in the pH of the wash liquor.

### BACKGROUND OF THE INVENTION

With the move to more environmentally friendly and sustainable laundry products, laundering processes, and laundry washing machine applications, there is a need to ensure that the fabric cleaning, fabric care and fabric freshness profiles of laundry detergent powders remain acceptable. With lower wash temperatures, the dissolution performance is impaired, and the fabric deposition performance is also affected by lowering the wash temperature. In addition, the reaction kinetics of the laundering processes is reduced with lower wash temperatures. The bleaching performance of the laundry detergent powder is particularly reduced at lower laundering temperatures.

The Inventors have overcome these problems by providing a laundry detergent powder having a dynamic pH profile that changes during the washing cycle. Without wishing to be bound by theory, the Inventors believe that providing an initial high pH provides excellent bleaching performance, especially for tetra-acetyl ethylene diamine (TAED) and percarbonate type bleach systems, and especially when the TAED and percarbonate are in close proximity to each other, e.g. such as in the form of co-particle. The bleach system can also be further improved by the incorporation of bleach catalysts such as oxaziridinium-based bleach catalyst, transition metal bleach catalysts and/or bleaching enzymes.

Without wishing to be bound by theory, the Inventors believe that a subsequent reduction in pH improves the fabric integrity and fabric care profiles at low washing temperatures, and enhances the cleaning performance of technologies such as enzymes. Reducing the wash pH also enables the incorporation of technologies such as cellulases and transition metal bleach catalysts to further improve the cleaning performance, and still provides a laundry detergent powder having excellent tensile strength loss profile.

Lipase and hueing agents may also be incorporated and the dynamic pH profile of the laundry detergent composition further improves the performance of these detergent ingredients. The dynamic pH profile improves the overall compatibility of detergent ingredients, providing excellent cleaning, freshness and care profiles at low washing temperatures, such as washing temperatures of 20° C. or less, or 15° C. or less, or even 10° C. or less.

Such dynamic pH profiles can be provided by reducing the buffering capacity (e.g. the reserve alkalinity) of the detergent composition, by providing initial alkalinity to the wash liquor, e.g. by silicate salts, or even sodium hydroxide, and by delaying the release of acid to the wash liquor, e.g. by coating means such as coating an acid source, (e.g. citric acid) with a coating such as wax. Other means of delaying the release of acid relative the release of alkalinity can also be used, for example by controlling the particle size distribution of the alkalinity source relative to the acid source.

### SUMMARY OF THE INVENTION

The present invention provides a solid free-flowing solid laundry detergent composition comprising:

(a) detersive surfactant;

(b) essentially free from zeolite builder;

(c) essentially free from phosphate builder; and

(d) optionally, essentially free from silicate salt;

wherein the composition has a reserve alkalinity to pH 7.5 of less than 15, and wherein upon dilution in de-ionised water to form a wash liquor at 10° C. temperature and at 1 g/L concentration has a pH profile such that:
(i) 3 minutes after contact with water, the pH of the wash liquor is greater than 10;
(ii) 10 mins after contact with water, the pH of the wash liquor is less than 9.5;
(iii) 20 mins after contact with water, the pH of the wash liquor is less than 9.0; and
(iv) optionally, wherein, the equilibrium pH of the wash liquor is in the range of from above 7.0 to 8.5.

### DETAILED DESCRIPTION OF THE INVENTION

Free-flowing solid laundry detergent composition. The free-flowing solid laundry detergent composition comprises: (a) detersive surfactant; (b) from 0 wt % to 10 wt % zeolite builder; (c) from 0 wt % to 10 wt % phosphate builder; and (d) optionally from 0 wt % to 10 wt % silicate salt; wherein the composition has a reserve alkalinity to pH 7.5 of less than 15, and wherein upon dilution in de-ionised water to form a wash liquor at 10° C. temperature and at 1 g/L concentration has a pH profile such that: (i) 3 minutes after contact with water, the pH of the wash liquor is greater than 10; (ii) 10 mins after contact with water, the pH of the wash liquor is less than 9.5; (iii) 20 mins after contact with water, the pH of the wash liquor is less than 9.0; and (iv) optionally, wherein, the equilibrium pH of the wash liquor is in the range of from above 7.0 to 8.5.

Typically, the solid laundry detergent composition is a fully formulated laundry detergent composition, not a portion thereof such as a spray-drying or agglomerate particle that only forms part of the laundry detergent composition. Typically, the solid laundry detergent composition comprises a plurality of chemically different particles, such as spray-dried base detergent particles and/or agglomerate base detergent particles and/or extrudate base detergent particles, in combination with one or more, typically two or more, or three or more, or four or more, or five or more, or six or more, or even ten or more particles selected from: surfactant particles, including surfactant agglomerates, surfactant extrudates, surfactant needles, surfactant noodles, surfactant flakes; builder particles, such as sodium carbonate and sodium silicate particles, phosphate particles, zeolite particles, silicate salt particles, carbonate salt particles; polymer particles such as cellulosic polymer particles, polyester particles, polyamine particles, terephthalate polymer particles, polyethylene glycol based polymer particles; aesthetic particles such as coloured noodles or needles or lamellae particles; enzyme particles such as protease prills, lipase prills, cellulase prills, amylase prills, mannanase prills, pectate lyase prills, xyloglucanase prills, and co-prills of any of these enzymes; bleach particles, such as percarbonate particles, especially coated percarbonate particles, such as percarbonate coated with carbonate salt, sulphate salt, silicate salt, borosilicate salt, or combinations thereof, perborate particles, bleach catalyst particles such as transition metal catalyst particles, or isoquinolinium bleach catalyst particles, pre-formed peracid particles, especially coated pre-formed peracid particles; filler particles such as sulphate salt particles; clay particles such as montmorillonite particles or particles of clay and silicone; flocculant particles such as polyethylene oxide particles, wax particles such as wax agglomerates, brightener particles, dye transfer inhibition particles; dye fixative particles, perfume particles such as perfume microcapsules and starch encapsulated perfume accord particles, or pro-perfume particles such as Schiff base reaction product particles, bleach activator particles such as oxybenzene sulphonate bleach activator particles and tetra acetyl ethylene diamine bleach activator particles; hueing dye particles; chelant particles such as chelant agglomerates; and any combination thereof.

Reserve alkalinity. As used herein, the term “reserve alkalinity” is a measure of the buffering capacity of the laundry detergent composition (g/NaOH/100 g detergent composition) determined by titrating a 1% (w/v) solution of detergent composition with hydrochloric acid to pH 7.5 i.e in order to calculate Reserve Alkalinity as defined herein:

$$Reserve Alkalinity ( to pH 7.5 ) as \% alkali in g NaOH / 100 g product = \frac{T \times M \times 40 \times Vol}{10 \times Wt \times Aliquot}$$

T=titre (ml) to pH 7.5
M=Molarity of HCl=0.2
40=Molecular weight of NaOH
Vol=Total volume (ie. 1000 ml)
W=Weight of product (10 g)
Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free de-ionised water. Agitate using a magnetic stirrer on a stirring plate at 150 rpm until fully dissolved and for at least 15 minutes. Transfer the contents of the beaker to al litre volumetric flask and make up to 1 litre with deionised water. Mix well and take a 100 mls±1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.5. Note the millilitres of hydrochloric acid used. Take the average titre of three identical repeats. Carry out the calculation described above to calculate the reserve alkalinity to pH 7.5.

Preferably, the composition has a reserve alkalinity to pH 7.5 of less than 15, or less than 14, or less than 13, or less than 12, or less than 11, or less than 10, or less than 9, or less than 8, or less than 7, or less than 6, or less than 5, or even less than 4, or less than 3, or less than 2.

pH profile. The detergent composition, upon dilution in de-ionised water to form a wash liquor at 10° C. temperature and at 1 g/L concentration, has a pH profile such that: (i) 3 minutes after contact with water, the pH of the wash liquor is greater than 10, preferably greater than 10.5, or even greater than 11; (ii) 10 mins after contact with water, the pH of the wash liquor is less than 9.5, preferably less than 9.0. or even less than 8.5; and (iii) 20 mins after contact with water, the pH of the wash liquor is less than 9.0, preferably less than 8.5, or even less than 8.0; and (iv) optionally, wherein, the equilibrium pH of the wash liquor is in the range of from above 7.0 to 8.5, preferably from 7.5 to 8.5.

Detersive surfactant. Suitable detersive surfactants include anionic detersive surfactants, non-ionic detersive surfactant, cationic detersive surfactants, zwitterionic detersive surfactants and amphoteric detersive surfactants.

Preferred anionic detersive surfactants include sulphate and sulphonate detersive surfactants.

Preferred sulphonate detersive surfactants include alkyl benzene sulphonate, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Preferred sulphate detersive surfactants include alkyl sulphate, preferably C₈₋₁₈ alkyl sulphate, or predominantly C₁₋₂ alkyl sulphate.

Another preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 1 to 20, preferably from 1 to 10, preferably the alkyl alkoxylated sulphate is a C₈₋₁₈ alkyl ethoxylated sulphate having an average degree of ethoxylation of from 1 to 10, preferably from 1 to 7, more preferably from 1 to 5 and most preferably from 1 to 3.

The alkyl sulphate, alkyl alkoxylated sulphate and alkyl benzene sulphonates may be linear or branched, substituted or un-substituted.

The detersive surfactant may be a mid-chain branched detersive surfactant, preferably a mid-chain branched anionic detersive surfactant, more preferably a mid-chain branched alkyl sulphate and/or a mid-chain branched alkyl benzene sulphonate, most preferably a mid-chain branched alkyl sulphate. Preferably, the mid-chain branches are C₁₋₄ alkyl groups, preferably methyl and/or ethyl groups.

Another suitable anionic detersive surfactant is alkyl ethoxy carboxylate. The anionic detersive surfactants are typically present in their salt form, typically being complexed with a suitable cation. Suitable counter-ions include Na⁺ and K⁺, substituted ammonium such as C₁-C₆ alkanolammonium preferably mono-ethanolamine (MEA) tri-ethanolamine (TEA), di-ethanolamine (DEA), and any mixtures thereof.

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, preferably having an average degree of alkoxylation of from 1 to 30; alkylpolysaccharides, preferably alkylpolyglycosides; polyhydroxy fatty acid amides; ether capped poly(oxyalkylated) alcohol surfactants; and mixtures thereof.

Preferred non-ionic detersive surfactants are alkyl polyglucoside and/or an alkyl alkoxylated alcohol.

Preferred non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactant having the formula:

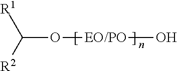

wherein R¹=linear or branched, substituted or unsubstituted, saturated or unsaturated C₂₋₈ alkyl;
wherein R²=linear or branched, substituted or unsubstituted, saturated or unsaturated C₂₋₈ alkyl,
wherein the total number of carbon atoms present in R¹+R² moieties is in the range of from 7 to 13;
wherein EO/PO are alkoxy moieties selected from ethoxy, propoxy, or mixtures thereof, preferably the EO/PO alkoxyl moieties are in random or block configuration;
wherein n is the average degree of alkoxylation and is in the range of from 4 to 10.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable zwitterionic and/or amphoteric detersive surfactants include alkanolamine sulpho-betaines.

Zeolite builder. The composition typically comprises from 0 wt % to 10 wt %, zeolite builder, preferably to 8 wt %, or to 6 wt %, or to 4 wt %, or to 3 wt %, or to 2 wt %, or even to 1 wt % zeolite builder. The composition may even be substantially free of zeolite builder; substantially free means “no deliberately added”. Typical zeolite builders include zeolite A, zeolite P and zeolite MAP.

Phosphate builder. The composition typically comprises from 0 wt % to 10 wt % phosphate builder, preferably to 8 wt %, or to 6 wt %, or to 4 wt %, or to 3 wt %, or to 2 wt %, or even to 1 wt % phosphate builder. The composition may even be substantially free of phosphate builder; substantially free means “no deliberately added”. A typical phosphate builder is sodium tri-polyphosphate.

Silicate salt. The composition may preferably comprise from 0 wt % to 10 wt % silicate salt, preferably to 9 wt %, or to 8 wt %, or to 7 wt %, or to 6 wt %, or to 5 wt %, or to 4 wt %, or to 3 wt %, or even to 2 wt %, and preferably from above 0 wt %, or from 0.5 wt %, or even from 1 wt % silicate salt. A preferred silicate salt is sodium silicate. Sodium meta-silicate is also a preferred silicate salt.

Carbonate salt. A suitable carbonate salt is sodium carbonate and/or sodium bicarbonate. Preferably, the composition comprises a bicarbonate salt. It may be preferred for the composition to comprise low levels of carbonate salt, for example, it may be preferred for the composition to comprise from 0 wt % to 10 wt % carbonate salt, preferably to 8 wt %, or to 6 wt %, or to 4 wt %, or to 3 wt %, or to 2 wt %, or even to 1 wt % carbonate salt. The composition may even be substantially free of carbonate salt; substantially free means “no deliberately added”.

Alkalinity source. Preferably, the composition comprises an alkalinity source. Preferred alkalinity source includes silicate salt, preferably metasilicate, such as sodium metasilicate. Another preferred alkalinity source is sodium hydroxide. Typically, the alkalinity source is capable of releasing alkalinity into the wash liquor very quickly, especially relative to the release of acid. This can be achieved, for example by controlling the particle size distribution of the alkalinity source, or by ensuring the alkalinity source is substantially uncoated.

Acid source. Preferably, the composition comprises an acid source. Preferred acid sources are organic acids, such as citric acid. Other acid sources include acrylic acid, maleic acid (or maleic anhydride), fumaric acid, itaconic acid, aconitic acid, mesaconic acid, citraconic acid, methylenemalonic acid, and any mixture thereof.

Typically, the acid source is capable of releasing acidity into the wash liquor slowly, especially relative to the release of alkalinity. This can be achieved, for example by controlling the particle size distribution of the acid source, or by ensuring the acid source is, at least partially, preferably substantially completely, coated. Preferably, the composition comprises coated acid source. Preferably, the coated acid source is wax coated citric acid.

The acid source may also be the combination of citric acid with another acid source, such as palmitic acid, and the acid source can even be in the form of a co-particle comprising citric acid and palmitic acid.

Enzymatic dynamic pH. In addition to a coated source of acid, another way of achieving the desired pH profile is to use an enzyme or enzyme/substrate combination designed to either release a source of acidity or destroy sources of alkalinity in the wash. Preferred enzymatic dynamic pH systems include (i) lipase/ester, (ii) perhydrolase/ester, (iii) cutinase/ester, (iv) carbohydrate oxidase/carbohydrate, and (v) carbonic anhydrase/bicarbonate. Suitable lipases include first-wash Humicola lanuginosa lipase variants such as Lipex and Lipoclean, commercially available from Novozymes, and Pseudomonas sp. lipases such as Lumafast and Lipomax, commercially available from Genencor. Suitable perhydrolases include variants of the Mycobacterium smegmatis perhydrolase disclosed in WO/2010/030769 (Genencor), and variants of so-called CE-7 perhydrolases disclosed in WO/2010/039958 (Du Pont). Suitable cutinases include the wild-type and variants of the cutinase derived from Pseudomonas putida ATCC 53552 described in U.S. Pat. No. 4,981,611 (Genencor).

In order to achieve the desired pH drop, the lipase, cutinase or perhydrolase is formulated with a suitable ester such as an ester of an aliphatic and/or aromatic carboxylic acid or alcohol. Suitable ester substrates are esters of one or more of the following: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. Preferred esters include monoacetin, triacetin, tributyrin, propylene glycol diacetate, ethylene glycol diacetate, ethyl acetate, glucose pentaacetate, xylose tetraacetate, acetylated xylan, other mono- or diesters of 1,2-ethanediol, 1,2-propanediol, 1,3-propanediol, 1,2-butanediol, 1,3-butanediol, 2,3-butanediol, 1,4-butanediol, 1,2-pentanediol, 1,6-hexanediol, or any combinations thereof. A source of hydrogen peroxide may be present, and when a perhydrolase is present this will impact the degree to which the ester substrate is perhydrolysed vs hydrolysed, although both routes have the desired impact on pH.

Suitable carbohydrate oxidases include carbohydrate:acceptor oxidoreductases, such as the carbohydrate:acceptor oxidoreductase endogenous to Microdochium nivale CBS 100236 described in WO 99/31990 (Novozymes) and hexose oxidase, such as the marine algal hexose oxidase described in WO 96/40935 (Bioteknologisk Institut). Other suitable carbohydrate oxidases include glucose oxidase, cellobiose dehydrogenase, pyranose oxidase and galactose oxidase. Those skilled in the art are able to select suitable carbohydrate substrates for these carbohydrate oxidases, for example glucose for glucose oxidase; lactose or cellodextrins for the carbohydrate:acceptor oxidoreductase endogenous to Microdochium nivale CBS 100236; galactose or galactose-containing polysaccharides such as xyloglucan or guar gum for galactose oxidase.

Suitable carbonic anhydrases fall into E.C. 4.2.1.1, and catalyse the dehydration of bicarbonate ions, leading to formation of carbon dioxide and consequent reduction in pH. Bicarbonate can be present in the wash liquor through formulated alkali metal carbonate or bicarbonate, with the ratio of carbonate:bicarbonate governed by the equilibria below. i.e. Bicarbonate does not need to be intentionally formulated—a source of sodium carbonate will equilibrate in the wash to produce the bicarbonate substrate for the enzyme. Sodium sesquicarbonate is a suitable source of both carbonate and bicarbonate ions.

Bleach particle. Preferably, the composition comprises bleach activator, such as tetra-ethylene diamine (TAED) and a source of hydrogen peroxide, such as sodium percarbonate. Preferably, the source of hydrogen peroxide, preferably the sodium percarbonate is in the form of a co-particle that additionally comprises a bleach activator, preferably tetra-ethylene diamine (TAED). It is highly preferred for a large amount of bleach activator relative to the source of hydrogen peroxide to be present in the laundry detergent composition. Preferably, the weight ratio of bleach activator to source of hydrogen peroxide present in the laundry detergent composition is at least 0.5:1, at least 0.6:1, at least 0.7:1, 0.8:1, preferably at least 0.9:1, or 1.0:1.0, or even 1.2:1 or higher.

Preferably, the composition comprises a bleach particle, wherein the bleach particle comprises: (i) bleach activator, preferably TAED; and (ii) a source of hydrogen peroxide, preferably sodium percarbonate. Highly preferably, the bleach activator at least partially, preferably completely, encloses the source of hydrogen peroxide

Bleach catalyst. Preferably the composition comprises bleach catalyst. Preferred bleach catalysts include oxaziridinium-based bleach catalysts, transition metal bleach catalysts, bleaching enzymes, and any combination thereof.

Preferably, the composition comprises oxaziridinium-based bleach catalyst having the formula:

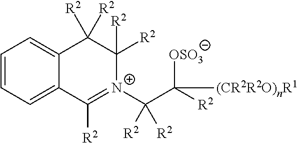

wherein: R¹ is selected from the group consisting of: H, a branched alkyl group containing from 3 to 24 carbons, and a linear alkyl group containing from 1 to 24 carbons; preferably, R¹ is a branched alkyl group comprising from 6 to 18 carbons, or a linear alkyl group comprising from 5 to 18 carbons, more preferably each R¹ is selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons; preferably R² is independently selected from H and methyl groups; and n is an integer from 0 to 1.

Lipase. Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus) as described in EP 258 068 and EP 305 216 or from H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al. (1993), Biochemica et Biophysica Acta, 1131, 253-360), B. stearothermophilus (JP 64/744992) or B. pumilus (WO 91/16422).

The lipase may be a “first cycle lipase” such as those described in U.S. Pat. No. 6,939,702 and US PA 2009/0217464. In one aspect, the lipase is a first-wash lipase, preferably a variant of the wild-type lipase from Thermomyces lanuginosus comprising T231R and N233R mutations. The wild-type sequence is the 269 amino acids (amino acids 23-291) of the Swissprot accession number Swiss-Prot O59952 (derived from Thermomyces lanuginosus (Humicola lanuginosa)). Preferred lipases would include those sold under the tradenames Lipex®, Lipolex® and Lipoclean® by Novozymes, Bagsvaerd, Denmark.

Preferably, the composition comprises a variant of Thermomyces lanuginosa lipase having >90% identity with the wild type amino acid and comprising substitution(s) at T231 and/or N233, preferably T231R and/or N233R.

Protease. Suitable proteases include metalloproteases and/or serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936, U.S. Pat. No. 5,679,630, U.S. Pat. No. 4,760,025, U.S. Pat. No. 7,262,042 and WO09/021,867.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, including those derived from Bacillus amyloliquefaciens described in WO 07/044,993.

Preferred proteases include those derived from Bacillus gibsonii or Bacillus Lentus.

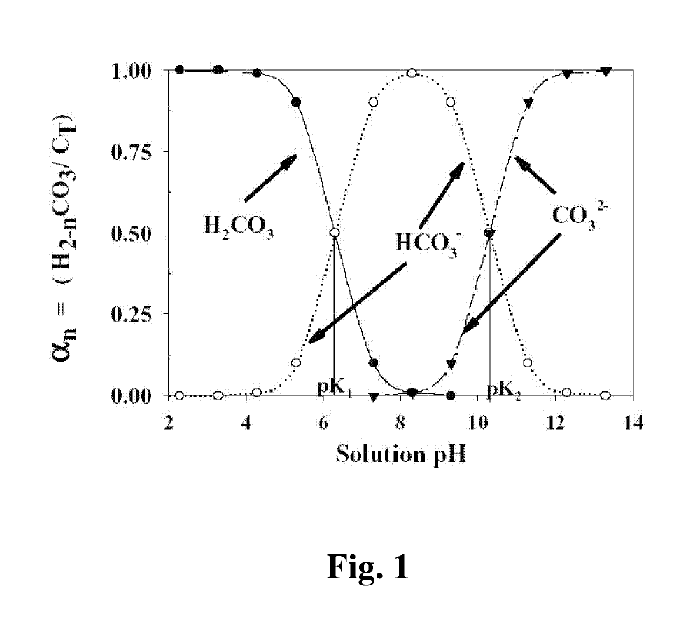

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V2051) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

Preferably, the composition comprises a subtilisin protease selected from BLAP, BLAP R, BLAP X or BLAP F49.

Cellulase. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include CELLUZYME®, and CAREZYME® (Novozymes A/S), CLAZINASE®, and PURADAX HA® (Genencor International Inc.), and KAC-500(B)® (Kao Corporation).

In one aspect, the cellulase can include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403) and mixtures thereof. Suitable endoglucanases are sold under the tradenames Celluclean® and Whitezyme® (Novozymes A/S, Bagsvaerd, Denmark).

Preferably, the composition comprises a cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

Amylase. Preferably, the composition comprises an amylase with greater than 60% identity to the AA560 alpha amylase endogenous to Bacillus sp. DSM 12649, preferably a variant of the AA560 alpha amylase endogenous to Bacillus sp. DSM 12649 having:

(a) mutations at one or more of positions 9, 26, 149. 182, 186, 202, 257, 295, 299, 323, 339 and 345; and (b) optionally with one or more, preferably all of the substitutions and/or deletions in the following positions: 118, 183, 184, 195, 320 and 458, which if present preferably comprise R118K, D183*, G184*, N195F, R320K and/or R458K.

Suitable commercially available amylase enzymes include Stainzyme® Plus, Stainzyme®, Natalase, Termamyl®, Termamyl® Ultra, Liquezyme® SZ (all Novozymes, Bagsvaerd, Denmark) and Spezyme® AA or Ultraphlow (Genencor, Palo Alto, USA).

Choline oxidase. Preferably, the composition comprises a choline oxidase enzyme such as the 59.1 kDa choline oxidase enzyme endogenous to Arthrobacter nicotianae, produced using the techniques disclosed in D. Ribitsch et al., Applied Microbiology and Biotechnology, Volume 81, Number 5, pp 875-886, (2009).

Other enzymes. Other suitable enzymes are peroxidases/oxidases, which include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include GUARDZYME® (Novozymes A/S).

Other preferred enzymes include pectate lyases sold under the tradenames Pectawash®, Pectaway® and mannanases sold under the tradenames Mannaway® (all from Novozymes A/S, Bagsvaerd, Denmark), and Purabrite® (Genencor International Inc., Palo Alto, Calif.).

Identity. The relativity between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

Other detergent ingredients. The composition typically comprises other detergent ingredients. Suitable detergent ingredients include: transition metal bleach catalysts; oxaziridinium-based bleach catalysts; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; fillers such as sodium sulphate, although it may be preferred for the composition to be substantially free of fillers; carbonate salt including sodium carbonate and/or sodium bicarbonate; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

A method of laundering fabric. The method of laundering fabric typically comprises the step of contacting a laundry detergent composition to water to form a wash liquor, and laundering fabric in said wash liquor, wherein typically the wash liquor has a temperature of above 0° C. to 20° C., preferably to 19° C., or to 18° C., or to 17° C., or to 16° C., or to 15° C., or to 14° C., or to 13° C., or to 12° C., or to 11° C., or to 10° C., or to 9° C., or to 8° C., or to 7° C., or to 6° C., or even to 5° C. The fabric may be contacted to the water prior to, or after, or simultaneous with, contacting the laundry detergent composition with water.

Typically, the wash liquor is formed by contacting the laundry detergent to water in such an amount so that the concentration of laundry detergent composition in the wash liquor is from above 0 g/l to 5 g/l, preferably from 1 g/l, and preferably to 4.5 g/l, or to 4.0 g/l, or to 3.5 g/l, or to 3.0 g/l, or to 2.5 g/l, or even to 2.0 g/l, or even to 1.5 g/l.

Highly preferably, the method of laundering fabric is carried out in a front-loading automatic washing machine. In this embodiment, the wash liquor formed and concentration of laundry detergent composition in the wash liquor is that of the main wash cycle. Any input of water during any optional rinsing step(s) that typically occurs when laundering fabric using a front-loading automatic washing machine is not included when determining the volume of the wash liquor. Of course, any suitable automatic washing machine may be used, although it is extremely highly preferred that a front-loading automatic washing machine is used.

It is highly preferred for the wash liquor to comprise 40 litres or less of water, preferably 35 litres or less, preferably 30 litres or less, preferably 25 litres or less, preferably 20 litres or less, preferably 15 litres or less, preferably 12 litres or less, preferably 10 litres or less, preferably 8 litres or less, or even 6 litres or less of water. Preferably, the wash liquor comprises from above 0 to 15 litres, or from 1 litre, or from 2 litres, or from 3 litres, and preferably to 12 litres, or to 10 litres, or even to 8 litres of water. Most preferably, the wash liquor comprises from 1 litre, or from 2 litres, or from 3 litres, or from 4 litres, or even from 5 litres of water.

Typically from 0.01 kg to 2 kg of fabric per litre of wash liquor is dosed into said wash liquor. Typically from 0.01 kg, or from 0.02 kg, or from 0.03 kg, or from 0.05 kg, or from 0.07 kg, or from 0.10 kg, or from 0.12 kg, or from 0.15 kg, or from 0.18 kg, or from 0.20 kg, or from 0.22 kg, or from 0.25 kg fabric per litre of wash liquor is dosed into said wash liquor.

Preferably 50 g or less, more preferably 45 g or less, or 40 g or less, or 35 g or less, or 30 g or less, or 25 g or less, or 20 g or less, or even 15 g or less, or even 10 g or less of laundry detergent composition is contacted to water to form the wash liquor.

Preferably, the laundry detergent composition is contacted to from above 0 litres, preferably from above 1 litre, and preferably to 70 litres or less of water to form the wash liquor, or preferably to 40 litres or less of water, or preferably to 35 litres or less, or preferably to 30 litres or less, or preferably to 25 litres or less, or preferably to 20 litres or less, or preferably to 15 litres or less, or preferably to 12 litres or less, or preferably to 10 litres or less, or preferably to 8 litres or less, or even to 6 litres or less of water to form the wash liquor.

### EXAMPLES

### Example 1

### Process of Making Palmitic Acid/Citric Acid Co-Particles

800 g of coarse citric acid (d₅₀ of 900 micrometers) is heated to 80° C. in an oven in a bowl. 200 g of palmitic acid (GPR grade from VWR) is heated so that the palmitic is allowed to melt. The melted palmitic acid is then coated onto the coarse citric acid particles in the bowl by mixing by hand with a spatula.

The hot mix is then allowed to cool in ambient conditions with constant mixing and agitation during cooling. The mix was kept moving during solidification of the palmitic acid to avoid the formation of large solid lumps and 10 g of Sipernat D17 hydrophobic silica can be added at this point to help minimise the formation of any overs. Once the mix is cool it is sieved through a 1.7 mm sieve to remove overs.

### Example 2

### Free-Flowing Particulate Laundry Detergent Compositions

| Ingredient | Composition A | | Composition B | | Composition C | | Composition D | |
|---|---|---|---|---|---|---|---|---|
| Linear alkyl benzene sulphonate | 15 | w % | 12 | wt % | 18 | wt % | 15 | wt % |
| Alkyl ethoxyalted sulphate having | 5 | wt % | 4 | wt % | 4 | wt % | 5 | wt % |
| an average degree of ethoxylation | | | | | | | | |
| of from 0.5 to 3 | | | | | | | | |
| Cationic detersive surfactant | 1 | wt % | 2 | wt % | 0.5 | wt % | 1 | wt % |
| Sodium sulphate | 20 | wt % | 25 | wt % | 25 | wt % | 20 | wt % |
| Sodium carbonate | 12 | wt % | 10 | wt % | 10 | wt % | 12 | wt % |
| Palmitic acid/citric acid | 9 | wt % | 10 | wt % | 10 | wt % | 12 | wt % |
| particles of example 1. | | | | | | | | |
| Co-particle of percarbonate and | 18 | wt % | 20 | wt % | 15 | wt % | 15 | wt % |
| tetra-acetyl ethylene diamine | | | | | | | | |
| Oxaziridinium-based bleach catalyst | 0.05 | wt % | 0.05 | wt % | 0.05 | wt % | 0.05 | wt % |
| Sodium silicate | 5 | wt % | 3 | wt % | 0 | wt % | 5 | wt % |
| Carboxylate polymer | 3 | wt % | 2 | w % | 5 | wt % | 2 | wt % |
| Brightener | 0.03 | wt % | 0.03 | wt % | 0.03 | wt % | 0.03 | wt % |
| Enzymes | 1.2 | wt % | 1.2 | wt % | 1.2 | wt % | 1.2 | wt % |
| Cellulosic polymer | 0.4 | wt % | 0.4 | wt % | 0.5 | wt % | 0.5 | wt % |
| Misc & Moisture | to 100 | wt % | to 100 | wt % | to 100 | wt % | to 100 | wt % |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A free-flowing solid laundry detergent composition comprising:
(a) detersive surfactant;
(b) essentially free from zeolite builder;
(c) essentially free from phosphate builder; and
(d) optionally, essentially free from silicate salt;
wherein the composition has a reserve alkalinity to pH 7.5 of less than 15, and wherein upon dilution in de-ionised water to form a wash liquor at 10° C. temperature and at 1 g/L concentration has a pH profile such that:
(i) 3 minutes after contact with water, the pH of the wash liquor is greater than 10;
(ii) 10 mins after contact with water, the pH of the wash liquor is less than 9.5;
(iii) 20 mins after contact with water, the pH of the wash liquor is less than 9.0; and
(iv) optionally, wherein, the equilibrium pH of the wash liquor is in the range of from above 7.0 to 8.5.

2. A composition according to claim 1, wherein the composition has a reserve alkalinity to pH 7.5 of less than 8.

3. A composition according to claim 1, wherein the composition comprises from above 0 wt % to 10 wt % carbonate salt.

4. A composition according to claim 1, wherein the composition comprises sodium bicarbonate.

5. A composition according to claim 1, wherein the composition comprises sodium hydroxide.

6. A composition according to claim 1, wherein the composition comprises a coated acid source.

7. A composition according to claim 6, wherein the coated acid source is wax coated citric acid.

8. A composition according to claim 1, wherein the composition comprises TAED and percarbonate

9. A composition according to claim 8, wherein the composition comprises a bleach particle, wherein the bleach particle comprises TAED and percarbonate.

10. A composition according to claim 1, wherein the composition comprises oxaziridinium-based bleach catalyst having the formula: 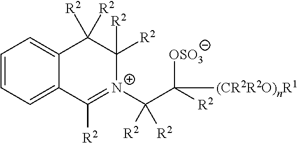
wherein:
R¹ is selected from the group consisting of: H, a branched alkyl group containing from 3 to 24 carbons, and a linear alkyl group containing from 1 to 24 carbons; R² is independently selected from the group consisting of: H, a branched alkyl group comprising from 3 to 12 carbons, and a linear alkyl group comprising from 1 to 12 carbons; and n is an integer from 0 to 1.

11. A composition according to claim 1, wherein the composition comprises transition metal bleach catalyst.

12. A composition according to claim 1, wherein the composition comprises bleaching enzyme.

13. A composition according to claim 1, wherein the composition comprises cellulase.

14. A composition according to claim 1, wherein the composition comprises lipase.

15. A method of laundering fabric comprising the step of contacting a laundry detergent composition according to any preceding claims to water to form a wash liquor, and laundering fabric in said wash liquor, wherein the wash liquor has a temperature of above 0° C. to 20° C.
